(19) United States
(12) Patent Application Publication
(10) Pub. No.: US 2020/0320789 A1
(43) Pub. Date: Oct. 8, 2020

(54) 3D IMMERSIVE INTERACTION PLATFORM WITH CONTEXTUAL INTELLIGENCE

(71) Applicant: INFINIQO, INC., Skillman, NJ (US)

(72) Inventors: Ramakrishna DURISETI, Skillman, NJ (US); Jamie McKINNEY, Bloomfield, NJ (US)

(21) Appl. No.: 16/837,849

(22) Filed: Apr. 1, 2020

Related U.S. Application Data
(60) Provisional application No. 62/828,050, filed on Apr. 2, 2019.

(51) Int. Cl. G06T 19/00; G06F 3/0482; G06F 3/0481; A63F 13/525; G09B 7/06

(52) U.S. Cl. CPC G06T 19/003; G06F 3/0482; G06F 3/04815; G09B 19/0053; G09B 7/06; G06T 2200/24; A63F 13/525

(57) ABSTRACT

The present invention relates to a system and a method of providing information through a virtual three dimensional (3D) simulation, that performs the steps of: receiving a user input from a user device, creating and rendering a virtual 3D environment based on the user input and configured logic transmitting the rendered 3D environment to the user device, displaying the rendered 3D environment to the user device and wherein the rendered 3D environment serves as a direct user interface thereby allowing the user to visually navigate the rendered 3D environment.

### FIELD OF INVENTION

The present invention relates to a virtual digital engagement platform particularly for a three-dimensional (3D) immersive interaction with contextual intelligence capability, designed for enterprises and individuals.

### BACKGROUND

The current systems and methods for accessing information are typically based on traditional static two-dimensional (2D) content and textual display. This information displayed is not intuitive or engaging and often requires the user to navigate through diversified content before reading the desired information.

Unfortunately, this method is fastidious and time-consuming, making it an uninteresting and tedious experience for the user especially during learning.

Thus, in light of this assessment, there is a need for a new method which would enable engaging and efficient information access within a 3D virtual environment.

### OBJECT OF THE INVENTION

It is an object of the present invention to provide a highly intuitive interactive 3D environment for individuals and organizations.

It is a further object of the present invention to provide a 3D simulation platform that is configurable across various domains (public & private education, financial services such as banking and insurance, continuing medical education (CME), healthcare, emergency management, organization change management, local, state and federal government).

It is a further object of the present invention to provide an effective and visually intensive content presentation via Virtual Situation Rooms for insurance and cyber security via our Cyber Marine Series.

It is a further object of the present invention to provide context-specific relevant information through mechanisms of Artificial Intelligence that enables Decision Intelligence to be deployed throughout the platform experience.

It is a further object of the present invention to provide a virtual 3D environment with machine learning ability that understands the specific needs of the user and tailors the content accordingly.

It is a further object of the present invention to implement a virtual 3D environment with gaming simulation for providing an engaging and enjoyable experience.

### SUMMARY OF THE INVENTION

The above-mentioned needs are met by a computer-implemented method and system for providing information through a virtual three-dimensional interface.

A computer-implemented method for providing information through a virtual three dimensional (3D) interface, that performs the steps of: receiving a user input from a user device, creating and rendering a virtual 3D environment based on the user input, transmitting the rendered 3D environment to the user device, displaying the rendered 3D environment to the user device and wherein, the rendered 3D environment serves as a direct user interface thereby allowing the user to visually navigate the rendered 3D environment.

A computer program product for providing information through a virtual three dimensional (3D) interface, that performs the steps of: receiving a user input from a user device, creating and rendering a virtual 3D environment based on the user input, transmitting the rendered 3D environment to the user device, displaying the rendered 3D environment to the user device and wherein, the rendered 3D environment serves as a direct user interface thereby allowing the user to visually navigate the rendered 3D environment.

A computer-implemented system for providing information through a virtual 3D interface, that includes a plurality of domains, one or more mobile devices that allows users to access features of the provided domains, one or more servers, an API gateway coupled to a network and in communication with the web servers, a 3D simulation platform configurable across the domains that provides multiple features and functionalities to enable an immersive interaction in the 3D virtual digital environment.

### BRIEF DESCRIPTION OF THE DRAWINGS

FIG. 1 illustrates a high-level architecture of a Digital Engagement and Empowerment Platform (DEEP) according to an embodiment.

FIG. 2 illustrates the architecture framework of DEEP according to an embodiment.

FIG. 3 illustrates the layered components of DEEP according to an embodiment.

FIG. 4 illustrates the architecture of the Axon application built-in with DEEP according to an embodiment.

FIG. 5 is a flowchart describing the operations of the Axon application.

FIG. 6 illustrates an exemplary scenario of the Axon application.

FIG. 7 illustrates the architecture of the Traverse application built-in with DEEP according to an embodiment.

FIG. 8 illustrates a conceptual framework of the Traverse application.

FIG. 9 illustrates an exemplary scenario of the Traverse application.

FIG. 10 illustrates an exemplary framework of a four-dimensional user interface of the DEEP platform according to an embodiment.

FIG. 11 illustrates a business opportunity and model in the area of healthcare management.

FIG. 12 illustrates a design thinking framework that brings together a coherence of four dimensions to help derive impactful solutions to various business challenges and needs.

### DETAILED DESCRIPTION OF THE INVENTION

The foregoing and other objectives, features, and advantages of the invention will be more readily understood upon consideration of the following detailed description of the invention, taken in conjunction with the accompanying drawings.

The present invention relates to a Digital Engagement and Empowerment Platform (DEEP) that provides a foundation for various features and functionality that enable an immersive interaction in a 3D virtual digital environment. DEEP further combines visual interaction technologies (3D/VR(Virtual Reality)/AR (Augmented Reality)/MR(Mixed Reality)), business applications, data, content and Artificial Intelligence (AI) for providing users with vast possibilities and capabilities of a new customer experience (CX) paradigms.

DEEP is configurable across one or more domains and products such as but not limited to:
Axon
Traverse
Zone-in
LifeBuddy and
Zingo (a health-assist platform)

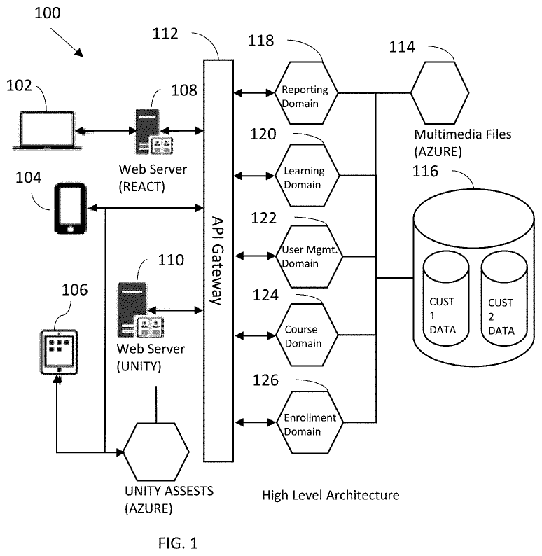

FIG. 1 illustrates a high-level architecture of a Digital Engagement and Empowerment Platform (DEEP). The DEEP 100 may include a learning domain 120, a user management domain 122, a reporting domain 118, a course domain 124, an enrollment domain 126, one or more mobile devices 102, 104 & 106, one or more web servers 108 & 110, an API gateway 112, one or more multimedia files 114 and a data store 116. One or more users can access the features of the provided domains using one or more mobile devices 102, 104 & 106 across a network through an API gateway 112 in communication with the web servers 108 & 110. Further, each domain of DEEP may be configured to exchange and retrieve information from data store 116 and multimedia files 114.

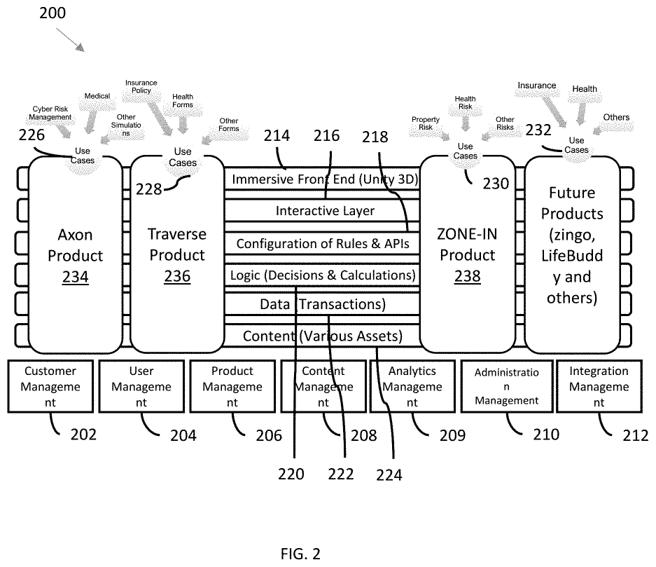

FIG. 2 illustrates the architecture framework 200 of the DEEP according to an embodiment with the built-in one or more products. The DEEP framework 200 includes user management functional architecture 204 that supports easy, intuitive and secure user management with contemporary authentication features. A customer management function 202 may be designed to furnish wide varieties of enterprise structures and their customer engagement types. Further, customer management function 202 may be configured to track and store costs and accounting details for an enterprise. A content management function 208 is configured to store, retrieve and present the relevant information as per the context. Wherein, the content is stored in a well-defined manner with appropriate storage structures for easy and quick retrieval. Further, the stored content includes but is not limited to text, 2D/3D arts, voice, videos and the like. An analytic management function 209 is capable of aggregating the data and generating reports and insights based on the derived data. A product management function 206 includes information required to build a product, wherein the information is retrieved using decision tree algorithms. An administration management function 210 manages access management, content management, reporting and product configurations. And an integration management function 212 is configured to manage external interfaces and information providers.

The DEEP framework 200 further includes one or more component layers capable of providing one or more functionalists, the layers including but not limited to:

Immersive Front End layer 214: The layer 214 is designed to generate a user interface with 3D high-resolution gaming components that are capable of running on mobile devices and personal computers. The user interface further includes 2D/3D simulations and a provision to play multimedia content.

Interaction Layer 216: The layer 216 is configured to manage the communications within the platform using micro-services architecture. Wherein, the architecture is implemented using contemporary Application Programming Interface (API) technologies that are centrally managed through an API gateway providing control and security for the communications. The interaction elements supported by the layer 216 include but are not limited to: trailers, scenarios, situation rooms/scenes, Heads Up Display (HUD) elements, form template, context-sensitive content, event & journey maps.

Configuration of Rules & APIs Layer 218: This layer 218 abstracts the product features and rules to define configurable components. This enables product administrators to perform any variations to the platform without IT intervention.

Logic Layer 220: The layer 220 is designed to configure the flow of the product functionality using decision tree algorithms, data structures and Artificial Intelligence (AI). The segregation of these components provides greater re-usability and maintainability.

Data Layer 222: The layer 222 manages the data generated during user interactions. The gathered data is stored with its context and is accessed for analytics, reporting and AI processing.

Content Layer 224: The layer 224 is configured to define and run the products with abstraction and granularity. The abstraction and granularity of this layer 224 provide the agility in optimizing any product variations with minimum requirements.

Further, the DEEP platform framework 200 includes one or more use cases 226, 228, 230 & 232 defining the products and their respective functions across various domains. The products defined include but not limited to:
Axon 234: Axon allows the users to make better business decisions after experiencing its 3D simulated situations. The users may improve their awareness, readiness and responsiveness to various situations that might occur within organizations.
Traverse 236: Traverse provides users with an 3D immersive document interaction in a context sensitive intelligence environment.
Zone-in 238: Zone-in is a risk assessment application that enables users to extensively understand one's risk with properties, insurance and the like. It includes realistic scenarios powered with visual technologies and effective transposing of systemic and historical data for risk assessment.
Future Products includes Zingo, LifeBuddy and others. LifeBuddy is an interactive application that enables its users to build a trusted relationship to guide them through various financial decisions pertaining to Life Insurance and the like. It includes exploring realistic scenarios with “what-if” analysis thereby helping with effective decision making through events in life's journey. The application has built-in AI to present relevant information in a context-intelligent way.
Zingo: Zingo is a platform designed to assist members (patients/customers) with immersive and engaging ways to manage health conditions better, thus helping with reduced cost of care and improved wellbeing, and in the process, significantly reducing the health insurance expense for payers.

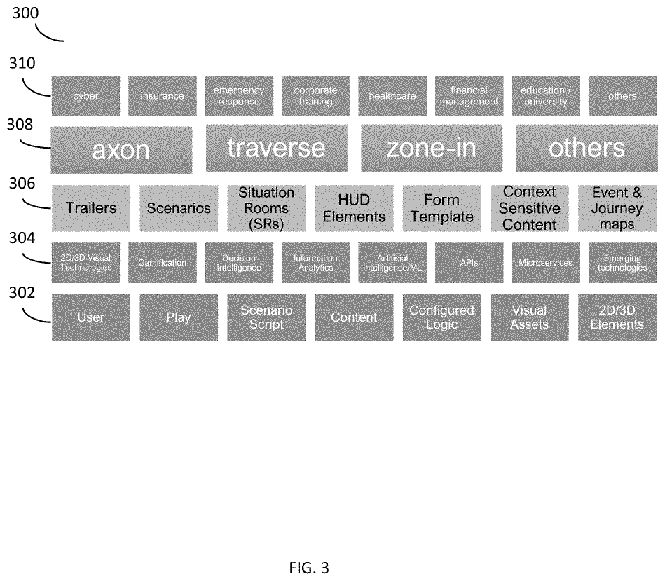

FIG. 3 illustrates the layered components 300 of the DEEP according to an embodiment. Wherein, each layer is encapsulated to enable an efficient way to architect the platform in a scalable and most effective manner giving the ability to the parent layer to leverage all the encapsulated capabilities in a modular manner According to an embodiment, as depicted in FIG. 3, 302 represents the data layer components, 304 depicts the components of a technology layer, 306 illustrates the components of the interaction layer, 308 represents the components of the products/application layer and 310 depicts the components of the user case layer.

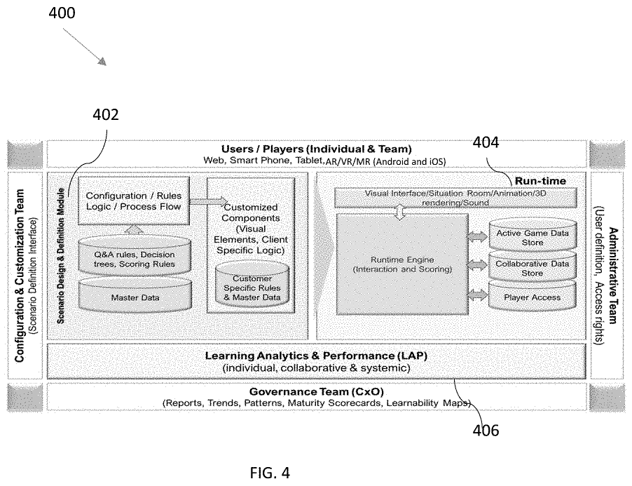

FIG. 4 illustrates the architecture 400 of the Axon application of the DEEP platform according to an embodiment. The architectural framework 400 includes Scenario Design & Definition Module 402 is configured to:
Define the backdrop and storyline for a trailer or a learning sequence for a user by using a decision tree algorithm for a sequence of interactive questions.
Define the questions and visuals for one or more difficulty levels
Establish the 3D renderings, 2D visuals, animated text to the respective backdrop, storyline trailer and question sequence.
Define the question scenario and its probable choices for the decision tree.
Allocate and define weights for each of the presented choice(s).
Define business rules to compute the total weighted score for a path.
Define a business rule for a correct and incorrect response for each question.
Present detailed process flow chart at one or more stages.

The architectural framework 400 further includes a run-time engine 404 that is configured to:

Allow users to select a game-based training scenario from the list of games/scenarios based on one or more parameters. Wherein, the parameters include but are not limited to the user's access rights, use cases and difficulty levels:
Executing the selected training scenario;
Evaluating a weighted score for each user at the end of the played story or game;
Generating a scorecard for the user based on the played story or game;
Incorporating built-in cognitive computing methods, face detection and voice recognition capabilities; and
Based on training performance, generating a learning sequence with cognitive computing and updated additional scenarios.

The architectural framework 400 further includes an analytics & visualization module 408 configured to:
Perform logical operations to deliver various analytics based on the interaction data across the platform
Generate Scorecards
Provide reports with insights of Patterns and Trends
Generate Learnability maps

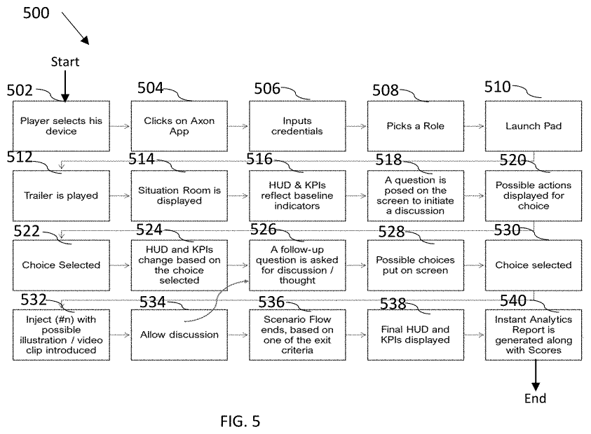

FIG. 5 is a flowchart 500 describing the flow of user experience for the Axon product. At step 502 & 504 the user chooses a device for selecting and accessing the installed Axon application. At step 506 the user inputs one's credentials and logs into the application. At step 508, user selects the scenario. At step 510 the application is launched, and the associated trailer is played at step 512. At step 514 the situation room is displayed along with the associated HUD (Heads Up Display) and KPI (Key Performance Indicators) with baseline indicators at step 516. At steps 518 & 519 a multiple-choice question is posed to the user to begin a discussion. At step 520 the user selects a choice from the set of options. Based on the selected choice, multimedia content is played at step 522 and discussion continues as in step 524, and reiterates the steps of 520 & 522 based on the user selected choice. At the end of the situation room exercise, the scenario is exited at step 536 and what is displayed is the final HUD and KPIs alongside the reports of the generated scores at steps 538 & 540.

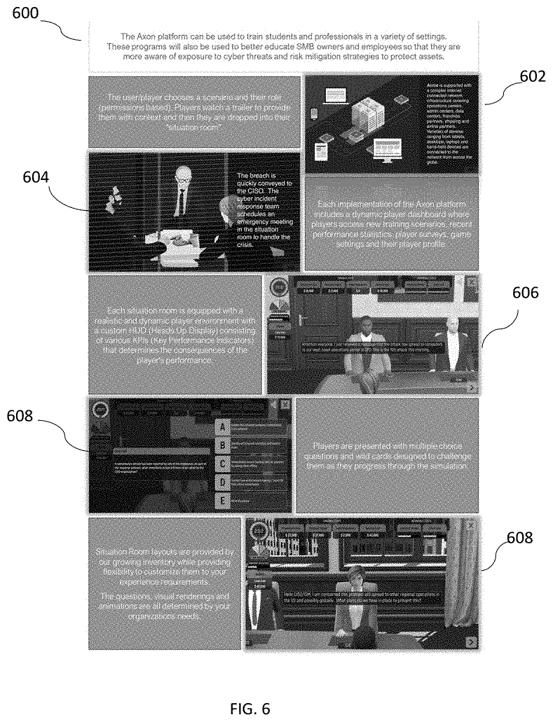

FIG. 6 illustrates an exemplary scenario 600 for the Axon application. This is a use case of a virtual cyber tabletop exercise that is designed to be used with representatives from small, medium and enterprise corporations to prepare them for cyber incidents. At 602 the user chooses a scenario and a trailer with 2D or 3D animation, voice and music is played for the user setting an environment for the simulated scenario. After the trailer is played, the application states the context of the scenario to the user at 604. At 606, the situation room with 3D modeled animated characters is displayed. Wherein, the situation room is equipped with a custom HUD and KPIs that track and determine the outcome of the user's performance. At 608 the user is presented with one or more multiple choice questions and based on the degree of correctness of the user's response, answers are weighted. 610 illustrates an example of camera movement and display of the voice-over in accordance with the scenario. Further, the platform includes a dynamic player dashboard enabling users to access training scenarios, performance statistics, game settings, surveys and user profile information.

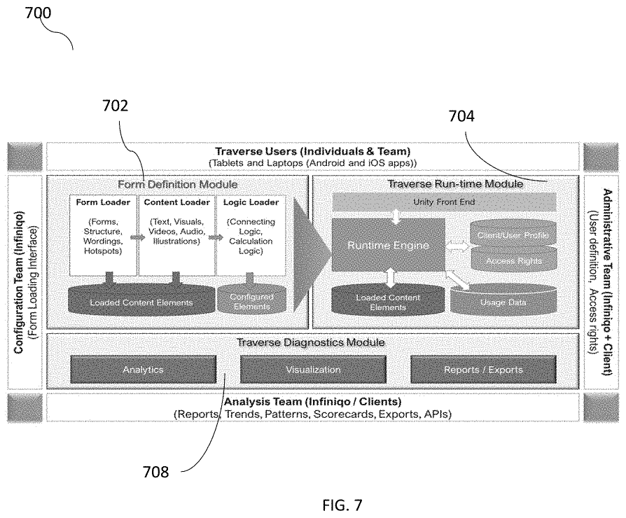

FIG. 7 illustrates the architecture 700 of the Traverse application built-in with DEEP platform according to an embodiment. The architectural framework 700 includes form definition module 702 that is configured to:

Define forms, structures, wordings & hotspots.

Define the visuals, illustrations, text, videos audios for the traversal content.

Define the logic and calculations for the traversal path of the content.

The architectural framework 700 further includes a Traverse run time module 704 designed to:
Allow users to select a document for traversal from the list of documents. Wherein, the parameters include but are not limited to the user's access rights, use cases and difficulty levels
Loading and executing content components and
Assessing the usage data.

The architectural framework 700 further includes a diagnostics module 708 is configured to:
Perform logical operations to deliver various analytics based on the interaction data across the platform
Provide reports with insights of Patterns and Trends

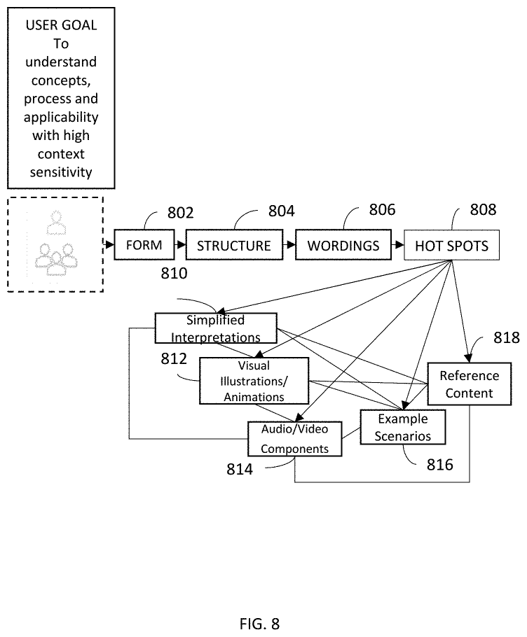

FIG. 8 illustrates a conceptual framework of the Traverse application. The Traverse product enables the user to understand the content, concepts and their applicability with high context sensitivity. Traverse breaks down the content into form 802, defines a structure 804 for the content and then defines the wordings 806 and assigns hotspots 808 for the content. The hotspots 808 generated may include simplified interpretations 810, static visual illustrations and or 2D/3D animations 812, example scenarios 814 and reference content 819.

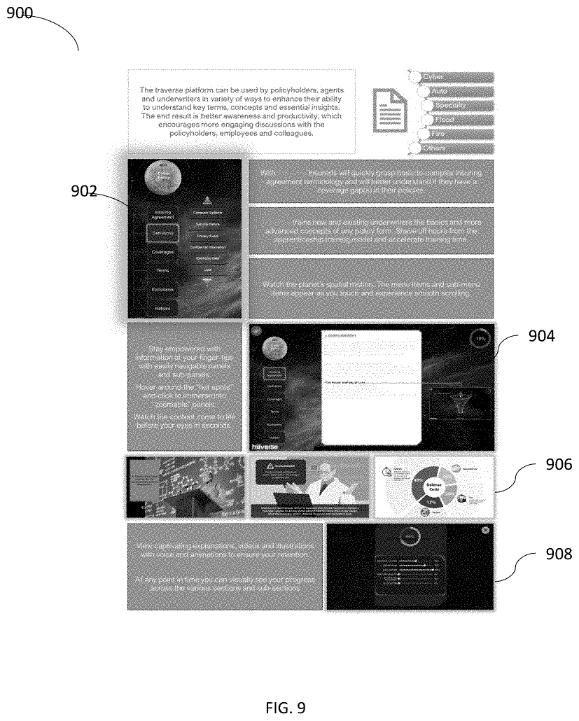

FIG. 9 illustrates an exemplary scenario 900 of a cyber policy traversed using the Traverse application. The Traverse application allows the user to selectively choose the concept from a drop-down list of concepts for understanding and learning the terminology as illustrated at 902. Wherein, the list of concepts may further include sub-sections listed as scroll-able sub-menus. The application includes navigational panels and sub-panels that provide additional and supporting content information through pop-ups. Wherein, the pop-ups can be further zoomed as shown at 904. As displayed at 906, the application presents the content with engaging explanations, videos, 2D/3D animated sequences, and still text ensuring the user's retention. Users can track their progress for a section as displayed at 908.

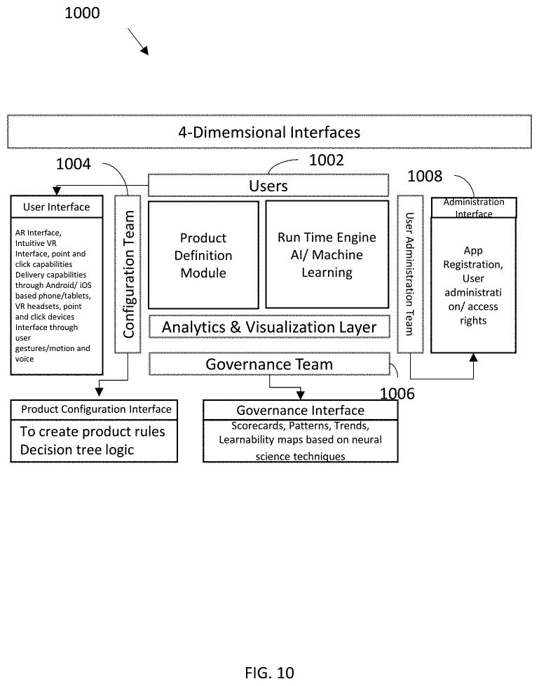

FIG. 10 illustrates the framework 1000 of a four-dimensional user interface of DEEP according to an embodiment. The framework 1000 includes a user interface 1002 comprising one or more interfaces such as an AR interface, an intuitive VR interface with point and click capabilities. The interface 1002 further captures the user's gestures, movements and voice. The framework 1000 further includes a product configuration interface 1004 configured to define product rules and to define the decision tree structure. The governance interface 1006 of the framework generates and manages the scorecards, patterns, trends and learnability maps based on neuroscience techniques. And the administrative interface 1008 manages and controls the user's credentials.

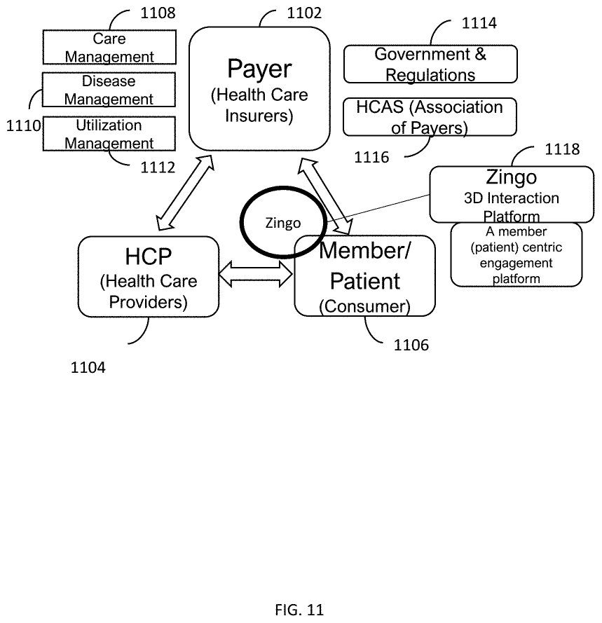

FIG. 11 illustrates a business opportunity and model in the area of healthcare management. This model may be referred to as “Zingo” 1118, a 3D Interaction Platform that aims to be a health-assist platform for the customers/members/patients. Typically, the model assists members with immersive and engaging ways to manage health conditions efficiently and effectively, thereby reducing the overall cost of care and health insurance.

Further, the model includes a Payer (Health Care Insurers) 1102, Health Care Providers (HCP) 1104 and Member/Patient (Consumer) 1106. The model takes into consideration several features for instance care management 1108, disease management 1110, utilization management 1112, government & regulations 1114 and HCAS (Association of Payers) 1116.

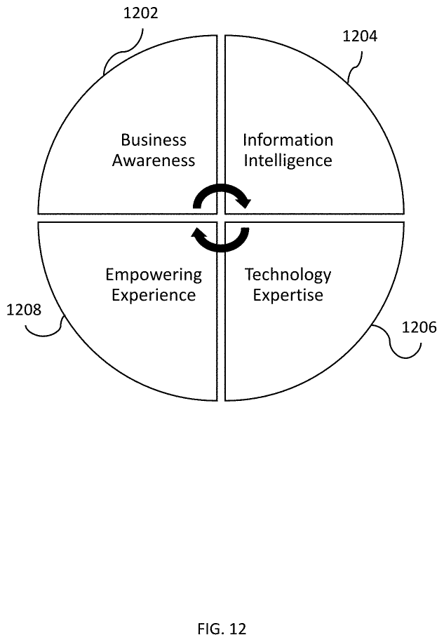

FIG. 12 illustrates a design thinking framework that brings together a coherence of four dimensions to help derive impactful solutions to various business challenges and needs.

The framework may be referred to “BITE framework” and includes four dimensions namely Business Awareness 1202, Information Intelligence 1204, Technology Expertise 1206, Empowering Experience 1208. The four dimensions come together to create a more effective and innovative solution thought process to create better business outcomes and models.

1. A computer-implemented method for providing information through a virtual three-dimensional (3D) simulation or interface, the computer-implemented method comprising:
receiving user input from a user device wherein the user input are credentials that allow the user to access an application configured within an interactive 3D environment platform and a desired scenario based on one or more parameters;
creating and rendering a virtual 3D environment based on the user input;
transmitting the rendered 3D environment to the user device;
displaying the rendered 3D environment to the user device; and
wherein the rendered 3D environment serves as a direct user interface allowing the user to visually navigate the rendered 3D environment.

2. The computer-implemented method of claim 1 wherein the rendered 3D environment is displayed with associated with Heads Up Display and Key Performance Indicators that reflects baseline indicators.

3. The computer-implemented method of claim 1 and further comprising:
displaying a question on the user interface to initiate a discussion along with possible actions displayed for multiple choices;
commencing the discussion with multiple choice questions; and
allowing the user to select a choice.

4. The computer-implemented method of claim 3 and further comprising:
presenting a multimedia content based on the choice;
generating scores at the end of the scenario based on an exit criterion; and
displaying final Heads Up Display and Key Performance Indicators and subsequently generating a report with the scores.

5. A computer program product stored on a non-transitory computer-readable medium that when executed by a processor, performs a method for providing information through a virtual three-dimensional (3D) simulation or interface, the computer program product comprising:
receiving user input from a user device wherein the user input are credentials that allow the user to access an application configured within an interactive 3D environment platform and a desired scenario based on one or more parameters;
creating and rendering a virtual 3D environment based on the user input;
transmitting the rendered 3D environment to the user device;
displaying the rendered 3D environment to the user device; and
wherein the rendered 3D environment serves as a direct user interface allowing the user to visually navigate the rendered 3D environment thereby providing an immersive interaction in the 3D environment.

6. The computer program product of claim 5 wherein the rendered 3D environment is displayed with associated with Heads Up Display and Key Performance Indicators that reflects baseline indicators.

7. The computer program product of claim 5 and further comprising:
displaying a question on the user interface to initiate a discussion along with possible actions displayed for multiple choices;
commencing the discussion with multiple choice questions; and
allowing the user to select a choice.

8. The computer program product of claim 7 and further comprising:
presenting a multimedia content based on the choice;
generating scores at the end of the scenario based on an exit criterion; and
displaying final Heads Up Display and Key Performance Indicators and subsequently generating a report with the scores.

9. A computer-implemented system executed by a computing device for providing information through a virtual three-dimensional (3D) simulation or interface, the system comprising:
a plurality of domains;
one or more mobile devices that allows users to access features of the provided domains; one or more web servers;
an API gateway coupled to a network and in communication with the web servers;
a 3D simulation platform configurable across the domains that provides multiple features and functionalities to enable an immersive interaction in the 3D virtual digital environment.

10. The system of claim 9 wherein the 3D simulation platform provides users with multiple possibilities and capabilities of a new customer experience paradigms.

11. The system of claim 9 wherein the domains comprise a learning domain, a user management domain, a reporting domain, a course domain and an enrollment domain.

12. The system of claim 9 and further comprising:
a database to store, retrieve and exchange information and multimedia files.

13. The system of claim 12 wherein each domain is allowed to exchange and retrieve information from the database and multimedia files.

14. The system of claim 9 and further comprising:
one or more products configured within the interactive 3D simulation platform.

15. The system of claim 9 and further comprising:
one or more component layers capable of providing one or more functionalities.

16. The system of claim 9 and further comprising:
a 3D gaming engine that allows immersive learning experience and all modules communicate seamlessly with each other and have immediate access to the one or more mobile devices.

17. The system of claim 9 wherein the 3D simulation platform is configured with layered components wherein each layer allows a parent layer to leverage all the encapsulated capabilities in a modular manner.
